(19) United States
(12) Patent Application Publication
(10) Pub. No.: US 2006/0243843 A1
(43) Pub. Date: Nov. 2, 2006

(54) Pretensioner device for a seatbelt retractor

(75) Inventor: Gunter Clute, Bloomfield Hills, MI (US)

Correspondence Address: AUTOLIV ASP, 3350 AIRORT ROAD, OGDEN, UT, 84405, US

(73) Assignee: Autoliv ASP, Inc.

(21) Appl. No.: 11/115,583

(22) Filed: Apr. 27, 2005

(51) Int. Cl. B60R 22/46

(52) U.S. Cl. 242/374

(57) ABSTRACT

A device for pretensioning a seatbelt attached to a seatbelt retractor is provided. The device includes a frame, a spindle, a torsion member, a tread head, and a locking element. The frame is for fixedly attaching the seatbelt retractor to a vehicle structure. The spindle is supported by the frame for rotatable movement within the frame. The pretensioning device is connected to the spindle for rotating the spindle to tighten the seatbelt. The torsion member is disposed within the spindle and has a first end fixedly secured to the spindle and a second end fixedly secured to the pretensioning device. The tread head is selectively engaged to the spindle for preventing rotation of the spindle and protraction of the seatbelt. The locking element is for selectively locking the tread head to the spindle. During pretensioning the locking elements are disengaged to enable pretensioning via the torsion bar.

### TECHNICAL FIELD

The present invention relates to devices and methods for pretensioning the seatbelt prior to or during a vehicle collision.

### BACKGROUND

Pretensioning a seatbelt is well known in the art. Some devices for pretensioning seatbelts may be coupled to the tread head of a retractor in order to pretension via a torsion bar. The tread head is coupled to a torsion bar and the torsion bar is coupled to the spindle on which the seatbelt webbing is wound. As the tread head is rotated by the pretensioner, torque is transmitted through the torsion bar at a first end and then to the spindle at a second end to wind and thus retract the seatbelt webbing into the retractor. As well known in the art, once the pretensioner device has fully retracted the seatbelt webbing, the torsion bar will allow protraction of the seatbelt webbing under occupant loading during the vehicle collision providing a load limiting feature.

While prior art methods for pretensioning of the vehicle seatbelt through the tread head and torsion bar achieve their intended purpose many problems still exist. For example, pretensioner devices that are coupled to the tread head are difficult to package in the retractor and are located in close proximity to sensitive locking devices of the retractor. Further, this pretensioner arrangement may require an entirely new locking system.

Thus, there is a need for a new and improved pretensioner device for tensioning a seatbelt during a vehicle collision. This new and improved pretensioner should pretension the seatbelt through the torsion bar and not interfere with the retractor locking devices.

### SUMMARY

In an aspect of the invention a device for pretensioning a seatbelt attached to a seatbelt retractor is provided. The device includes a frame, a spindle, a torsion member, a tread head, and a locking element. The frame is for fixedly attaching the seatbelt retractor to a vehicle structure. The spindle is supported by the frame for rotatable movement within the frame. The pretensioning device is connected to the spindle for rotating the spindle to tighten the seatbelt. The torsion member is disposed within the spindle and has a first end fixedly secured to the spindle and a second end fixedly secured to the pretensioning device. The tread head is selectively engaged to the spindle for preventing rotation of the spindle and protraction of the seatbelt. The locking element is for selectively locking the tread head to the spindle.

In another aspect of the invention, the locking element is rotatably fixed to one of the tread head and the spindle.

In yet another aspect of the invention, the locking element is rotatably fixed to the spindle.

In yet another aspect of the invention, the locking element further includes a spring for biasing the locking element towards one of the tread head and the spindle.

In yet another aspect of the invention, the pretensioning device further includes a pretensioner ring and pretensioner rack wherein the ring and rack include teeth that engage whereby movement of the rack causes a corresponding rotation of the ring.

In yet another aspect of the invention the pretensioning device further includes a combustion chamber for combusting a combustible to cause a movement of the rack.

In yet another aspect of the invention the pretensioning device further includes a rack locker for preventing retraction of the rack.

In yet another aspect of the invention the pretensioning device further includes locking teeth for engagement with the rack locker to prevent movement of the rack.

In yet another aspect of the invention the pretensioning device further includes a spring for biasing the rack locker toward the locking teeth.

In still another aspect of the invention, an apparatus for pretensioning a seatbelt attached to a seatbelt retractor is provided. The apparatus includes a frame, a spindle, a pretensioning device, a torsion member, a tread head, and a locking element. The frame is for fixedly attaching the seatbelt retractor to a vehicle structure. The spindle is supported by the frame for rotatable movement within the frame. The pretensioning device has a clutch for selectively rotating the spindle to tighten the seatbelt. The pretensioning device further includes a ring fixedly secured to the clutch and a rack. The ring and rack include teeth that engage, whereby movement of the rack causes a corresponding rotation of the ring. The torsion member disposed within the spindle has a first end fixedly secured to the spindle and a second end fixedly secured to the clutch of the pretensioning device. The tread head is selectively engaged to the spindle for preventing rotation of the spindle and protraction of the seatbelt, and a locking element for selectively locking the tread head to the spindle.

These and other aspects and advantages of the present invention will become apparent upon reading the following detailed description of the invention in combination with the accompanying drawings.

### BRIEF DESCRIPTION OF THE DRAWINGS

FIG. 1 is a cross-sectional perspective view of a seatbelt retractor, in accordance with an embodiment of the present invention;

FIGS. 2 is a perspective end view of the seatbelt retractor of FIG. 1, in accordance with an embodiment of the present invention;

FIG. 3 is a schematic diagram of a pretensioner device that may be used with the seatbelt retractor shown in FIGS. 1 and 2, in accordance with an embodiment of the present invention; and

FIG. 4 is a schematic diagram of a pretensioner device that may be used with the seatbelt retractor shown in FIGS. 1 and 2, in accordance with an alternate embodiment of the present invention.

FIG. 5 is a schematic diagram of a pretensioner device that may be used with the seatbelt retractor shown in FIGS. 1 and 2, in accordance with an alternate embodiment of the present invention.

### DESCRIPTION

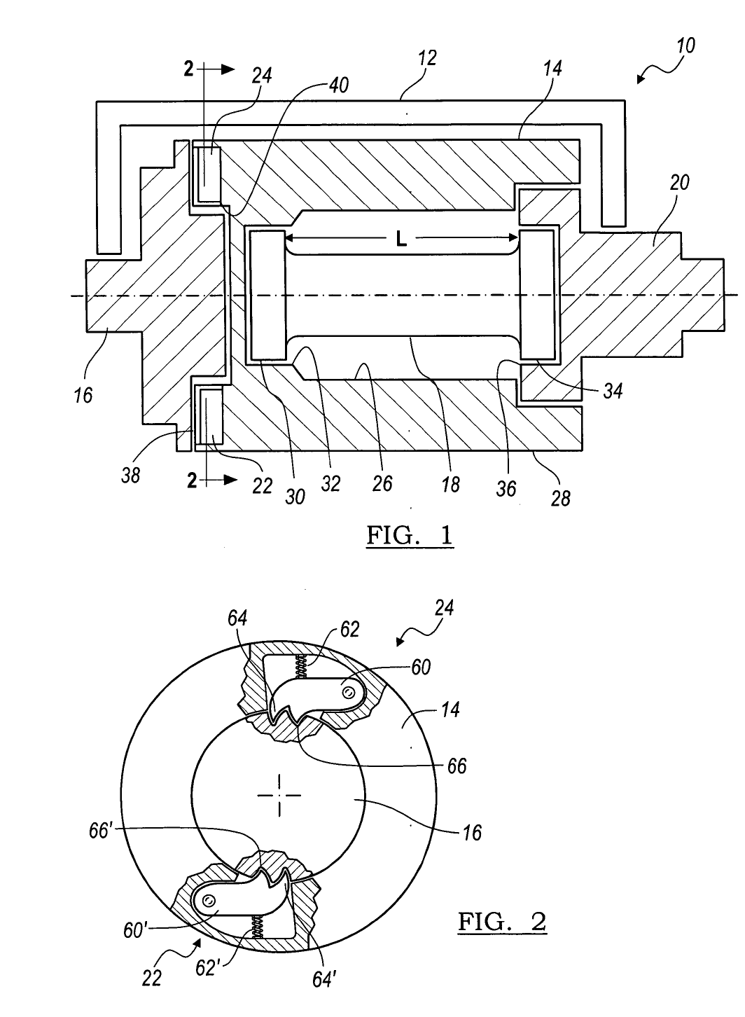

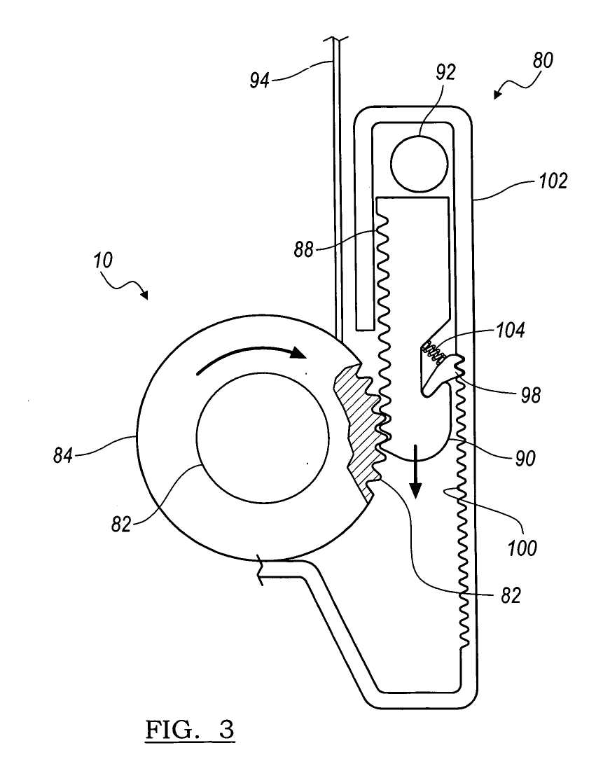

Referring now to FIG. 1, a perspective view of a seatbelt retractor 10 is illustrated, in accordance with an embodiment of the present invention. Seatbelt retractor 10 includes a frame 12, a spindle 14, tread head 16, a torsion bar 18 and a pretensioner end cap 20. Frame 12 is provided to secure the retractor to a vehicle structure (not shown) and support spindle 14. A seatbelt (shown as reference no. 94 in FIG. 3) is wound about spindle 14. As known in the art, as the spindle is rotated in a first direction the seatbelt webbing is retracted or wound onto spindle 14 and when the spindle is rotated in a second direction the seatbelt webbing is protracted or unwound from the spindle.

The tread head 16 is selectively coupled to spindle 14, as will be described in further detail below. Further, the tread head which is supported by frame 14 is selectively engaged by a locking pawl (not shown). The locking pawl is activated during certain driving conditions, such as a quick vehicle deceleration, to prevent rotation of the tread head, as well known in the art. Upon the locking of the tread head, spindle 14 is prevented from rotating which stops protraction of the seatbelt webbing from the retractor, as will be described further below.

Spindle 14 is, generally, a cylindrical member that is open at one end and has an internal surface that defines an internal cavity 26. Spindle 14 is configured for rotation within frame 12 and is disposed between tread head 16 and a pretensioner end cap 20. The seatbelt webbing is typically trapped by spindle 14 and in contact with and wound about an outer surface 28 of spindle 14.

The pretensioner end cap 20 is coupled to a pretensioner device typically through a clutch. The pretensioner device may be any known pretensioner device configured to quickly retract the seatbelt webbing. Alternatively, the pretensioner may be the device shown in FIG. 3 and described below.

A torsion bar 18 is disposed within cavity 26 of spindle 14. Torsion bar 18 has a first torsion bar end 30 and a second torsion bar end 34. First torsion bar end 30 is fixedly attached to a spindle end 32 to prevent relative movement therebetween. Further, second torsion bar end 34 is fixedly secured to a first end 36 of pretensioner end cap 20 to prevent relative movement therebetween. Torsion bar 18 has a length (L) and a diameter (D) which may be changed to accommodate different vehicle characteristics such as weight and length of vehicle, as well as, different occupant types, i.e. small or large. Torsion bar 18 acts as a load-limiting device. Upon loading of the seatbelt webbing during a vehicle impact, torsion bar 18 twists allowing spindle 14 to rotate to payout or protract a predefined amount of seatbelt webbing from retractor 10 to reduce or eliminate peak loads on the vehicle occupant.

Pretensioner end cap 20 is not attached to spindle 14. Pretensioner end cap 20 is disposed proximate to spindle 14 and opposite spindle end 32. In operation, pretensioner end cap 20 is acted on by a pretensioner device (i.e. shown in FIG. 3) to rotate spindle 14 through torsion bar 18. More specifically, end cap 20 rotates torsion bar end 34 causing torquing or twisting of torsion bar 18 along its length L to rotate torsion bar end 30 and spindle 14.

Tread head 16 and spindle 14 are configured to slidably mate at mating surfaces 38 and 40 of tread head 16 and spindle 14. Thus, spindle 14 will rotate relative to tread head 16. A pair of locking elements 22 and 24 are disposed in spindle 14. Locking elements 22 and 24 are configures to lock and rotationally fix spindle 14 to tread head 16 preventing relative rotation therebetween.

Referring now to FIG. 2, a cross-sectional view through retractor 10 as shown in FIG. 1, is further illustrated to provide a better understanding of how locking elements 22 and 24 are configured to engage tread head 16, in accordance with an embodiment of the present invention. Locking elements 22 and 24 include lock pawls 60 and 60′ which are pivotally mounted to spindle 14. Further, locking elements 22 and 24 include spring 62 and 62′ for biasing the lock pawl toward tread head 16. Lock pawls 60 and 60′ further include locking teeth 64 and 64′ which engage the features 66 and 66′ in tread head 16. Under normal operation, spindle 14 will wind and unwind the seatbelt webbing and spindle 14 will be rotationally fixed to tread head 16. However, during pretensioning of the seatbelt webbing (i.e. activation of the pretensioner device) rotational forces will cause lock pawls 60 and 60′ to rotate outwards and away from tread head 16 disengaging spindle 14 from tread head 16. This allows pretensioner end cap 20 to rotate spindle 14 through torsion bar 18 to wind additional seatbelt webbing onto spindle 14.

Referring now to FIG. 3, seatbelt retractor 10 is shown, schematically, engaged to a pretensioner device 80, in accordance with an embodiment of the present invention. While a particular pretensioner will be described, of course, the present invention contemplates other pretensioner devices that may be coupled to retractor 10 to provide pretensioning of the seatbelt webbing. Pretensioner 80 is coupled to a pretensioner clutch 82 via a pretensioner ring 84. Pretensioner clutch 82 selectively engages pretensioner end cap 20 upon activation of pretensioner device 80. Pretensioner ring 84 includes a plurality of teeth 86 which cooperatively engage teeth 88 on a pretensioner rack 90. A combustion chamber 92 is provided adjacent rack 90. Combustion chamber 92 includes combustible material that when activated expands forcing rack 90 downward in a direction, as indicated by arrow V. The linear translation of rack 90 is converted to a rotational movement of pretensioner ring 84 by the meshing engagement of teeth 86 of pretensioner ring 84 with teeth 88 of pretensioner rack 90. As pretensioner rack 90 is driven downward, pretensioner ring 84 is rotated in a direction indicated by arrow R. The rotation of pretensioner ring 84 causes a rapid winding of seatbelt webbing 94 onto spindle 14 thereby pretensioning the seatbelt 94.

Rack 90 further includes a rack lock member 98. Rack lock member 98 is configured to engage one of a plurality of notches 100 disposed in housing 92 of pretensioner 80. A spring 104 is provided between rack 90 and lock member 98 to bias lock member 98 toward the plurality of notches 100 disposed in housing 92. Thus, as rack 90 is driven downward in a direction V, lock member 98 travels over the plurality of notches 100 and comes to rest in one of the notches when rack 90 stops moving in the V direction. The locking of the rack 90 prevents rotation of pretensioner ring 84 and effectively locks the end cap 20 preventing protraction of the seatbelt webbing from retractor 10. Of course, protraction of seatbelt webbing 94 may still occur due to the twisting or torqing of torsion member 18 under loading of the seatbelt by the vehicle occupant.

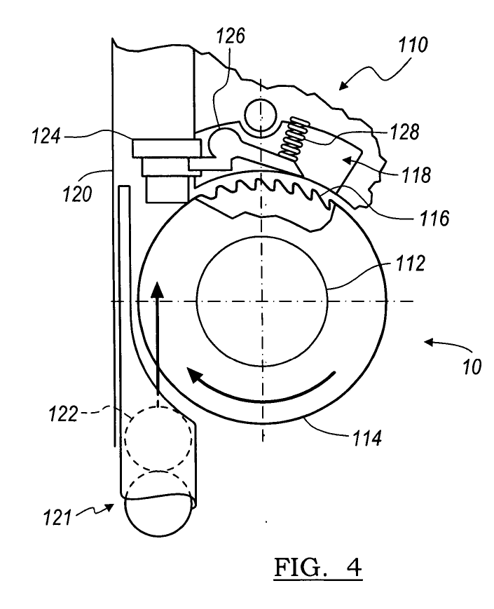

Referring now to FIG. 4, seatbelt retractor 10 is shown, schematically, engaged to a pretensioner device 110, in accordance with an embodiment of the present invention. While a particular pretensioner will be described, of course, the present invention contemplates other pretensioner devices that may be coupled to retractor 10 to provide pretensioning of the seatbelt webbing. Pretensioner 110 is coupled to the pretensioner clutch 112 via a pretensioner ring 114. Pretensioner clutch 112 selectively engages pretensioner end cap 20 upon activation of the pretensioner device 110. A roto pretensioner tube 120 is provided adjacent to pinion coupler 118. Roto pretensioner tube 120 contains pretensioner balls 121. After firing the pretensioner the leading ball 122 rotates the pretensioner ring 114 in order to initiate the webbing retraction (pull-in). After passing the pretensioner ring, the leading ball shears off the retaining tap 124 of pinion coupler 118. The shearing off the retaining tap 124 releases the locking lever 126 that is pushed by the lever spring 128 onto the teethed contour 116 of the pretensioner ring 114. The geometry of the lever 126 in conjunction with the lever spring 128 allows the pretensioner ring 114 to rotate in the pretensioning direction (pull-in) but locks it in the load limiter direction (webbing protraction or pull-out).

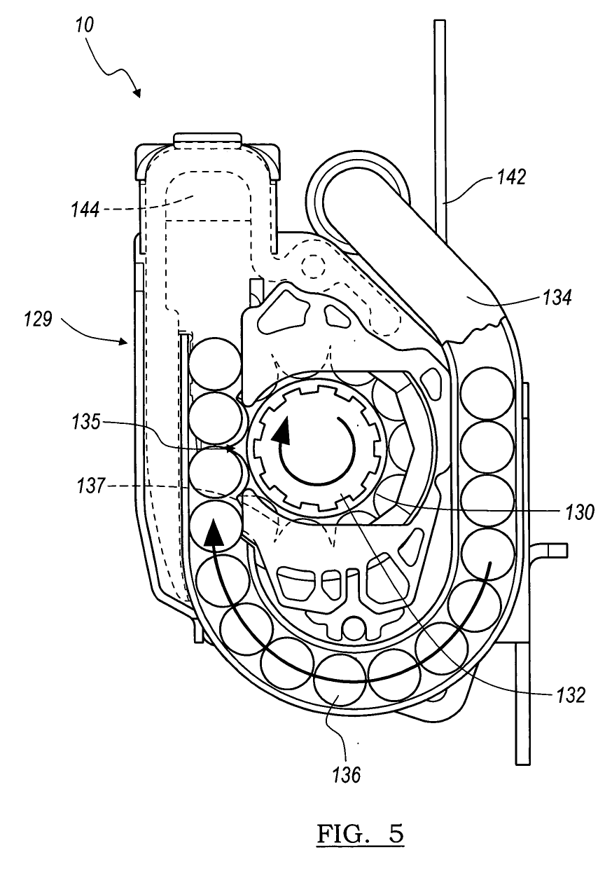

Referring now to FIG. 5, seatbelt retractor 10 is shown, schematically, engaged to a pretensioner device 129, in accordance with an embodiment of the present invention. While a particular pretensioner will be described, of course, the present invention contemplates other pretensioner devices that may be coupled to retractor 10 to provide pretensioning of the seatbelt webbing. Pretensioner 129 is coupled to the torsion bar (shown as reference no. 18 in FIG. 1) via a spindle 132. Spindle 132 is mechanically coupled to a pinion 130. Pinion 130 further comprises a plurality of teeth 137. A tube 134 is provided adjacent to pinion 130 and contains pretensioner balls 136. A gas (not shown) provides a pressure on the pretensioner balls 136 that moves the pretensioner balls 136 along the length of the tube 134. An opening 135 in the tube 134 and adjacent to pinion 130 allows the pretensioner balls 136 cooperatively engage teeth 137 of pinion 130. A ball trap 144 is provided at an end of the tube 134. The ball trap 144 prevents the continued movement of the pretensioner balls 136. The force provided by the pressure of the gas on pretensioner balls 136 decouples a locking element (not shown) between a tread head (not shown) and the spindle 132. The pretensioner balls 136 engage teeth 137 of the pinion 130 and pulls in the webbing 142. If force acting on the webbing 142 overcomes the pressure of the gas, the locking element (not shown) prevents any further movement in that direction (seatbelt protraction or pull-out) but allows movement in the opposite direction (seatbelt retraction or pull-in).

The present invention has many advantages and benefits over the prior art. For example, the present invention provides a pretensioning device and method for pretensioning a seatbelt webbing of a seatbelt retractor via the torsion bar that does not interfere with sensitive locking devices of the retractor. Further, the present invention allows the use of a pretensioner that may be packaged on the non-locking side of the retractor. In a normal operating state of the retractor, the tread head and spindle are rotationally fixed via the locking elements. In a pretensioning state, the pretensioner device is activated and the locking elements are released from the tread head by rotational forces acting on the inertial mass of the locking elements. The pretensioner retracts the seatbelt webbing via the torsion bar, thus pretensioning via the torsion bar. After the pretensioning phase, the pretensioner device holds the end cap fixed via the torsion bar and allows the torsion bar to twist and the spindle to rotate providing a load limiting feature. When the pretensioner is not activated, no load limiting feature is provided. The pretensioning via the torsion bar eliminates load limiter disturbances and holding the pretensioner under torsion bar load will eliminate or reduce the locking depth. Further, the present invention utilizes normal retractor locking (CSNVS) via the locking pawl on the tread head.

As any person skilled in the art of systems and methods for pretensioning the seatbelt prior to or during a vehicle collision will recognize from the previous detailed description and from the figures and claims, modifications and changes can be made to the preferred embodiments of the invention without departing from the scope of this invention defined in the following claims.

I claim:

1. A device for pretensioning a seatbelt attached to a seatbelt retractor, the device comprising:
a frame for fixedly attaching the seatbelt retractor to a vehicle structure;
a spindle supported by the frame for rotatable movement within the frame;
a pretensioning device connected to the spindle assembly for rotating the spindle to tighten the seatbelt;
a torsion member disposed within the spindle having a first end fixedly secured to the spindle and a second end fixedly secured to the pretensioning device;
a tread head selectively engaged to the spindle for preventing rotation of the spindle and protraction of the seatbelt; and
a locking element for selectively locking the tread head to the spindle.

2. The device of claim 1 wherein the locking element is disengaged from the spindle during the tightening of the seatbelt.

3. The device of claim 1 wherein the locking element is rotatably fixed to one of the tread head and the spindle.

4. The device of claim 3 wherein the locking element is rotatably fixed to the spindle.

5. The device of claim 1 wherein the locking element further includes a spring for biasing the locking element towards one of the tread head and the spindle.

6. The device of claim 1 wherein the pretensioning device further comprises a pretensioner ring and pretensioner rack wherein the ring and rack include teeth that engage whereby movement of the rack causes a corresponding rotation of the ring.

7. The device of claim 6 wherein the pretensioning device further comprises a combustion chamber for combusting a combustible to cause a movement of the rack.

8. The device of claim 6 wherein the pretensioning device further comprises a rack locker for preventing retraction of the rack.

9. The device of claim 6 wherein the pretensioning device further comprises locking teeth for engagement with the rack locker to prevent movement of the rack.

10. The device of claim 6 wherein the pretensioning device further comprises a spring for biasing the rack locker toward the locking teeth.

11. An apparatus for pretensioning a seatbelt attached to a seatbelt retractor, the apparatus comprising:
a frame for fixedly attaching the seatbelt retractor to a vehicle structure;
a spindle supported by the frame for rotatable movement within the frame;
a pretensioning device having a clutch for selectively rotating the spindle to tighten the seatbelt, and wherein the pretensioning device further includes a ring fixedly secured to the clutch and a rack, wherein the ring and rack include teeth that engage, whereby movement of the rack causes a corresponding rotation of the ring;
a torsion member disposed within the spindle having a first end fixedly secured to the spindle and a second end fixedly secured to the clutch of the pretensioning device;
a tread head selectively engaged to the spindle for preventing rotation of the spindle and protraction of the seatbelt; and
a locking element for selectively locking the tread head to the spindle.

12. The apparatus of claim 11 wherein the locking element is rotatably fixed to one of the tread head and the spindle.

13. The apparatus of claim 12 wherein the locking element is rotatably fixed to the spindle.

14. The apparatus of claim 11 wherein the locking element further includes a spring for biasing the locking element towards one of the tread head and the spindle.

15. The apparatus of claim 11 wherein the pretensioning device further comprises a housing enclosing the rack.

16. The apparatus of claim 15 wherein the housing defines a combustion chamber for combusting a combustible to cause a movement of the rack.

17. The apparatus of claim 15 wherein the pretensioning device further comprises a rack locker for preventing retraction of the rack within the housing.

18. The apparatus of claim 17 wherein the pretensioning device further comprises locking teeth disposed in the housing for engagement with the rack locker to prevent movement of the rack.

19. The apparatus of claim 17 wherein the pretensioning device further comprises a spring for biasing the rack locker toward the locking teeth.
